(19) United States
(12) Patent Application Publication
(10) Pub. No.: US 2006/0257006 A1
(43) Pub. Date: Nov. 16, 2006

(54) Device and method for combined display of angiograms and current x-ray images

(75) Inventors: Joerg Bredno, Aachen (DE); Kai Eck, Aachen (DE); Barbara Martin-Leung, Aachen (DE); Peter Maria Johannes Rongen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/568,477

(22) PCT Filed: Aug. 12, 2004
(86) PCT No.: PCT/IB04/51452

§ 371 Date: Feb. 15, 2006

(30) Foreign Application Priority Data
Aug. 21, 2003 (EP) 03102615.6
Nov. 12, 2003 (EP) 03104159.3

(51) Int. Cl. G06K 9/00

(52) U.S. Cl. 382/128

(57) ABSTRACT

The invention relates to a device and to a method for superimposed display of current (X-ray) image (A) of an object (8), such as a catheter for example, and a map image (B) of the vascular system. In this connection, for map images (B) archived in a memory (6) the associated distance images (D) are calculated by means of a distance transformation (A). In the current image (A) the object (8) is segmented (Σ). By means of the distance image (D), a transformation of the map image (B) is then calculated, so that, when the current image (A) and the transformed map image (Θ(B)) are superimposed on a monitor (10), the image of the object (8) lies in the path network of the transformed map image.

The invention relates to a device and to a method for combined display of a current image of an object, which is located in a path network such as in particular the vascular system of a patient, and a map image of the path network.

The combination of a current image of an object and a map image of the object surroundings is performed, for example, when navigating a catheter through the vascular system of a patient. The underlying problem will therefore be explained subsequently with the aid of an example of a cardiac catheter examination, although the present invention is not restricted to this area of application. In the case of the systems customarily used for cardiac treatment, static angiograms and fluoroscopic images currently being recorded are displayed on two different monitors side by side. Angiograms are here depictions of the vascular system, in which the vessels are displayed highlighted, for example by administering a contrast medium. In the case of these systems, it is left to the doctor carrying out treatment to relate the position of an object, such as, for example, a catheter or a guide wire, recognizable on the current picture, to the map image of the vascular system, that is, to superimpose in his mind the two monitor images displayed side by side.

In this context, a device is known from JP-A-2002-237996, in which a current fluoroscopic image and a static vascular map are superimposed on the same monitor. The difficulty with such superimpositions is that owing to an overall movement of the patient, as well as his heartbeat and breathing, the position and form of organs in the current images constantly change, so that to some extent considerable geometrical and anatomical discrepancies exist between the superimposed images. To alleviate this problem, data banks containing static vascular maps from different phases of the cardiac and/or respiratory cycle can be used in order by means of an electrocardiogram (ECG) and/or the measured respiration phase to allocate to a current fluoroscopic image the static vascular map (from the same or a similar cardiac or respiratory cycle) that is the best match for it. Even when using such advanced methods, geometric discrepancies between the superimposed images still remain, which can seriously impair the optical impression and consequently the usefulness of the superimposition. Furthermore, for parts of the body that are not subject to cyclical spontaneous movement (for example, the head, the extremities), the quality of the superimposition is also poor if map recording and imaging of the intervention procedure are carried out at separate times, because patient movements between recordings are, in the main, inevitable, and even reproduction of the image geometry is limited mechanically.

Improved superimpositions of current recordings and map images could in principle be achieved by transformations, which bring common image contents into register. Such methods, known as multimodality registration in the literature, can nevertheless not be applied in the above cases as a rule, since the map image of the path network and the current recording of an object in the path network have no relevant common image content. In particular, the objects in the path network (e.g. catheter, guide wire) correspond neither in form nor in appearance with the path network itself (contrast medium-filled blood vessels).

Against this background, it was an object of the present invention to provide means for improved, real-time combined display of a current image of an object and a map image of the path network in which the object is located.

That object is achieved by a device having the features of claim 1 as well as by a method having the features of claim 11. Advantageous embodiments are contained in the subsidiary claims.

The device according to the invention is used for combined display of an image of an object, which is located in a path network, and a map image of the (especially form-changing) path network. The first-mentioned image is referred to hereinafter as the “current image”, without a restriction being associated with this in relation to specific time periods. Neither are there any fundamental restrictions in respect of the dimensionality of the current image and the map image (1D, 2D, 3D, 4D, . . . ). The object can be, for example, a catheter or an intervention device (guide wire, stent, balloon) on a catheter, and the path network can be correspondingly the vascular system of a patient. Alternatively, however, the object can be, for example, a capsule located in the gastrointestinal tract of a patient, or a non-medical application can be involved. The typical feature is that the object is able to move only along the paths allowed by the path network. The map image preferably displays the path network in highlighted form. For example, the map image can be an angiogram that has been prepared from the vascular system of a patient to whom contrast medium has been administered. The device contains a data-processing system, which is arranged to perform the following steps:

In a map image to identify the path network by suitable segmentation. Segmentation is understood here in conventional manner to mean the assignment of pixels to different classes or objects. In the present case, the segmentation is able to determine in particular for each pixel of the map image whether it belongs to the path network or not. Segmentation can be effected fully automatically or alternatively where necessary semi-automatically, in other words, by interactive user intervention.

From the above-mentioned segmentation result to calculate auxiliary information and to archive it in the memory of the data-processing system, from which auxiliary information a transformation that brings the object and path network into register can be determined in real time for every possible position of an object in the image. What positions of the object are “possible” will depend primarily on the underlying application; in the extreme case, all possible positions on the image area can be regarded as eligible. Subject to the method used in step d), the information needed to be able to discover as quickly as possible the nearest plausible location in the path network for the possible positions of an object in the image is determined in advance in the auxiliary information.

The auxiliary information can in particular be in the form of an (auxiliary) image of the region of the path network. For a given position of an object, at the corresponding point of the auxiliary image it is then possible directly to remove information that is needed to determine a transformation in real time.

To segment from the current image a relevant object that is located in the path network. The fact that the object is located in the path network emerges typically not from the current image, but is based on the general conditions of the underlying application.

Using the auxiliary information from step b), to determine transformations of the map image and the current image, so that when the transformed map image and the transformed current image are superimposed, the image of the object comes to lie in the path network of the transformed map image. One of the mentioned transformations, e.g. that of the current image, is typically defined by the identity, so that only the map image is subjected to a “real” transformation. The transformations can incidentally be of any kind, that is, in particular linear or non-linear. In particular, a translation, a rotation and/or a scaling can be involved.

With the device described, it is possible to achieve an adjustment, based on an object such as a catheter for instance, of the superimposition of a current image and a map image, the constraint being exploited that the observed object must be located at all times in the path network. The superimposed images are therefore transformed in such a way that the path network displayed on the map image lies over the object displayed on the current image. In this way, registration on the basis of image contents (vessel, catheter etc.) is achieved, and the mismatches, particularly irritating for the user, when an object of interest does not lie or does not lie exactly in the path network, can be avoided. Moreover, it is important for the device that respective auxiliary information is calculated in advance for the map image used, the auxiliary information containing information about the path network and extending this information, for example, over the entire image area, so that it is immediately retrievable during the later intervention. This ultimately enables the superimposition to be carried out in real time, which is an indispensable prerequisite for maximum clinical usefulness of the device.

As was already mentioned, the auxiliary information can comprise in particular one or more images of the region of the path network. In this regard, the auxiliary information comprises preferably a distance image in relation to the path network, which is obtained from the particular map image by a distance transformation. A distance transformation is an operation known from digital image-processing (cf. Jähne, Digitale Bildverarbeitung, 5^{th} edition, Chapter 18, Springer Verlag Berlin Heidelberg, 2002). Here, a pixel of the distance image can in particular contain information about in which direction and/or at what distance from that point a specific segmentation object exists. Such a distance image is especially well suited for rapid determination of the required transformations, since it contains implicitly for each pixel the magnitude of the necessary displacement into the path network. In the important cases of application, in which the map image is known in advance, the associated distance image can be calculated in advance and stored in a memory. Later on, this enables calculation of the transformations to be carried out in real time during an ongoing intervention.

According to a preferred embodiment of the device, the data-processing system is arranged to perform the following individual steps:

b1) Determination of the position of the image of the object in the current image. For example, by segmentation, the position of a catheter or rather its tip can be determined in a fluoroscopic X-ray image. Apart from an individual point, the segmentation result can also contain an entire object, which in the superimposed view is supposed to lie as far as possible in the path network (a complete match is not always possible in the case of rapid, rigid transformations, especially in the case of biological path networks);

c1) Determination of the shortest displacement that in the best possible manner will transfer into the path network the position in the distance image that corresponds to the above-mentioned position of the object image in the current image. In other words, first of all one determines the corresponding position of the object image in the distance image is produced, which occurs when the position of the object image in the current image is transferred “one to one” or conforming to the geometric relations between the current image and the map image known from recording parameters. Normally, this corresponding position will lie completely or partially outside the path network, since a path network such as e.g. the vascular system is subject to constant displacement and deformation and therefore does not normally exist at the same point and in the same configuration on the map image and the current image;

c2) Identification of a transformation of the map image and/or of the current image that includes the above-mentioned displacement. This transformation can extend the displacement in particular globally to an entire image. The displacement can alternatively, however, be continued linearly or non-linearly, such that specific marginal conditions, for example, the invariance of the image edges, are satisfied.

In a preferred version of the device, the data-processing system is arranged to carry out a segmentation of the path network in the map image and at the same time to assign to each pixel of the map image a probability that it belongs to the network. In other words, a probability-based segmentation is carried out, in which the pixels are not sorted strictly into just one of two classes (belonging to the object or not), rather, only probabilities for an affiliation are assigned. This procedure better suits in particular the situation when processing medical data, since there, on account of the complexity of the structures depicted and the restricted image quality, generally speaking no really reliable decision can be made about the affiliation to a vessel or the like. At the same time, a meaningful gauge of the reliability of a result obtained can also be defined by the probability-based segmentation.

The device can in particular contain an imaging arrangement, for example an X-ray apparatus and/or an MRI apparatus, with which the current image of the object can be produced. Furthermore, the imaging arrangement can serve to generate also the map images of the residence region of the object. Such a device is especially suitable for navigation of a catheter during medical examinations. The device can also contain more than one imaging device, for example, an X-ray apparatus and an MRI apparatus, so that the current recording and the map image(s) can originate from different modalities.

According to a further aspect of the device, this contains a memory for storing a number of map images, the map images being categorized according to a varying state of the path network. In this instance it is possible to select from among the several map images an optimum map image for the combination to be effected.

The device contains furthermore preferably a sensor device for detecting at least one parameter that describes a varying state of the path network of the object. In particular, the sensor device can be arranged to detect an electrocardiogram and/or the respiratory cycle of a patient undergoing examination. Such a sensor device can be used in conjunction with the above-mentioned memory for a number of map images, in order on the one hand to categorize the stored map images according to the associated state of the path network and in order on the other hand to determine the state of the path network pertaining to the current image.

In conjunction with the above-mentioned embodiment of the device containing a memory, the data-processing system can furthermore be arranged to select from the memory of the device that map image of which the “index” or associated state of the path network is the best possible match for the state of the path network that existed as the current image was being taken. If, for example, the memory contains several map images of the vascular system of a patient at different phases of the cardiac cycle, one can select from these the one that comes from the same phase of the cardiac cycle as the current image. In this manner it is possible to take into account parameterizable and especially cyclical spontaneous movements of the path network and from the outset to combine the current image only with a map image that is the best possible match.

The device can in particular contain a display device linked to the data-processing system, on which the transformed map image is displayed superimposed entirely or in sections on the transformed current image or a section thereof. In the context of a catheter investigation, a doctor, for example, can then observe on the monitor fluoroscopic live images of the catheter, which at the same time show him the vascular structure around the catheter as a section of a vascular map.

The invention relates furthermore to a method for combined display of a current image of an object, which is located in a path network, and a map image of the path network, comprising the following steps:

a) segmentation of the path network in the map image;

b) calculation and storage of auxiliary information from the segmentation result, wherein for every possible position of an object in the image a transformation that brings the object and path network into register can be determined in real time from the auxiliary information;

c) segmentation of a relevant object that is located in the path network from the current image;

d) determination of transformations of the map image and the current image using the auxiliary information, so that, when the transformed map image and the transformed current image are superimposed, the image of the object comes to lie in the path network of the transformed map image.

The method implements in a general form the steps that can be performed with a device of the kind described above. For an explanation of the details, advantages and further aspects of the method, the reader is therefore referred to the above description. These and other aspects of the invention are apparent from and will be elucidated, by way of non-limitative example, with reference to the embodiments described hereinafter.

In the drawings:

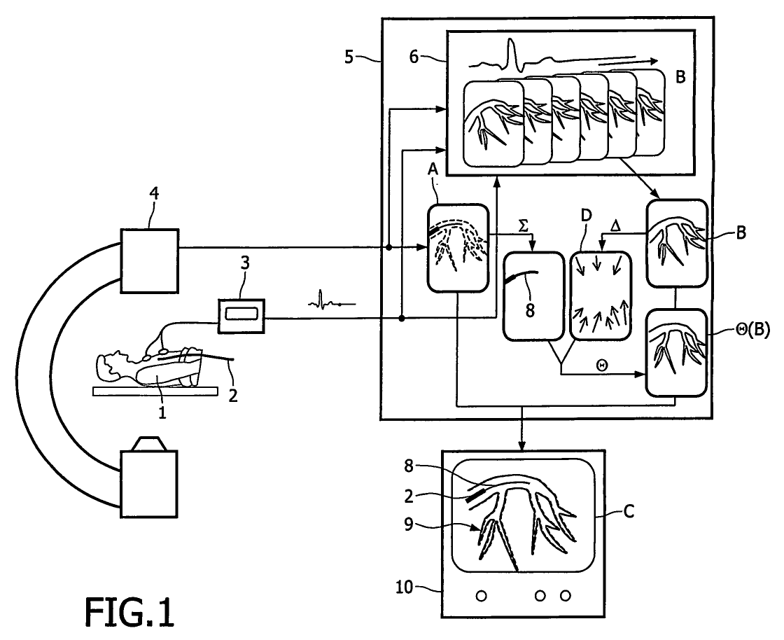

FIG. 1 shows the components of a device according to the invention for superimposed display of two images;

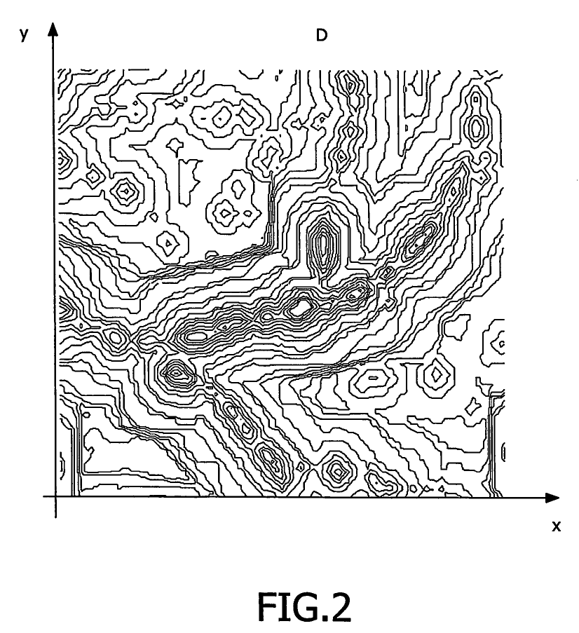

FIG. 2 is an illustration of an example distance image.

In the case of the medical application illustrated in the Figure as a representative example, the movement of a catheter 2 or more precisely of the catheter tip and/or a guide wire 8 in the vascular system 9 of a patient 1 is to be observed. For that purpose, fluoroscopic X-rays images of the body volume being examined are produced with an X-ray apparatus 4, and are transferred as current images A to a data-processing system 5. The difficulty with such fluoroscopic images is that the vascular system 9 does not usually stand out thereon, so that with this system reliable navigation of the catheter or a guide wire to a specific location within the vascular system is hardly possible. A better display of the vascular system could, admittedly, be achieved by injection of a contrast medium, but such measures must be used as sparingly as possible, owing to the stress associated therewith for the patient.

To improve catheter navigation, in the case of the system illustrated several angiograms B are prepared with the X-ray apparatus 4 before or during the actual catheter examination and are stored in a memory 6 of the data-processing system 5. The angiograms can be produced, for example, by injections of contrast medium, so that the vascular tree of the patient can easily be seen on them. They are therefore hereinafter referred to also as “map images or “vascular maps” (road maps).

Since the heartbeat has significant effects on the position and form of the vascular system of the heart and the adjoining organs, map images B from different phases of the cardiac cycle of the patient 1 are archived in the memory. The cardiac phase belonging to a particular map image B is here indicated by an electrocardiogram, which is recorded by an electrocardiograph 3 in parallel with the X-ray images. Furthermore, map images can be prepared also at different phases of the respiratory cycle, which is detected by a respiration sensor such as a chest belt or similar. For the sake of clarity, such an additional or alternative indication of the map images B by way of the respiratory cycle is not specifically shown in the Figure. The map images B could be subjected to further techniques for image improvement in order to improve the image quality for the superimposition.

During the catheter examination carried out for therapeutic or diagnostic purposes, fluoroscopic images A of the catheter tip or a guide wire 8 are continuously produced and passed together with the associated ECG to the data-processing system 5. The phase of the electrocardiogram or of the cardiac cycle pertaining to a current image A is then established by the data-processing system 5, and the map image B that matches this cardiac phase best is selected from the memory 6.

The current image A and the map image B can in principle be displayed side by side on two different monitors or superimposed on one another on the same monitor. Since the map image B to the matching cardiac phase was selected, the geometrical or anatomical correspondence between the images A, B thus superimposed would already be a comparatively good one. Nevertheless, because of parallax in the image production, because of soft tissue movement and as a result of similar influences, in practice slight discrepancies always appear between the superimposed aggregate images, and cannot be eliminated by transformations without analysis of the current image content. These discrepancies can be visually very disruptive and considerably reduce the usefulness of the superimposition.

To improve the image quality during the superimposition of two images, a registration method based on the position on the object to be imaged, that is to say, primarily the catheter or guide wire 8, is proposed. Within the scope of this method, in the map images B the vascular tree is roughly pre-segmented. Segmentation in image processing is understood to mean the assignment of pixels to objects.

In this connection, the registration method requires the selection of a suitable method for segmentation and a suitable method for preparation of the segmentation result, in order to aid a subsequent fast registration with objects in the vascular system. Both choices are to be effected with regard to a quick and robust algorithm for discovering the best-possible match between path network and current object. For the segmentation of blood vessels, the principle axis transformation of the local Hessian matrix (Schrijver M; “Angiographic image analysis to assess the severity of coronary stenoses”, Twente university press, Enschede, 2002) is suitable. Since in the case of real X-ray images of the vascular system it is not normally possible to assign a pixel reliably to a vessel, a probability-based segmentation is preferably effected here. In this, each pixel is assigned a value that describes the probability that the pixel belongs to a vessel. A multiplicative distance transformation with a hyperbolic mask, in which entries decrease with the inverse of the distance to the center, allows simple gradient descent optimizations even for complex path networks such a vascular trees having pathological modifications. Such a distance image D indicates locally in what direction from or at what distance from the point under consideration there is a greater probability of the presence of a vessel. The distance image D can be displayed visually by a height relief across an image area, the height of the points of the relief representing the distance to the vascular system. FIG. 2 shows in this connection the two-dimensional projection of the contours of an example relief. Calculation of the probability-based map images B and the associated distance images D can advantageously be effected off-line or in advance, the results being held in the memory 6. During a real-time application, such as the medical examination under consideration for example, these calculations do not impede implementation of the method.

After selecting from the memory 6 the map image B that best matches the current image A, the distance image D pertaining to this map image B is used to estimate the position of the object 8 of interest (catheter or guide wire) on the map image B. For that purpose, first of all, the (radio-opaque) object 8 is segmented in the current image A using a suitable segmentation method Σ. There are various algorithms available here, from which an optimum variant can be selected with respect to the underlying application, the intervention device being displayed as well as the real-time efficiency (Baert S A M, Niessen W J, Meijering E H W, Frangi A F, Viergever M A: “Guide wire tracking during endovascular interventions”, Proc. 3^{rd} MICCAI, 2000).

By a simple and quick gradient descent the distance image D can then be displaced so that the overlap between the position of the object 8 and the vessel regions becomes maximum. At the same time, only rigid displacements (shifts and/or rotations) of the segmented object relative to the map image B can be permitted, although non-linear transformations can be included as well if this has advantages in the specific application. The resulting transformation Θ is then applied to the map image B, and the transformed map image Θ(B) is then displayed on the monitor 10 superimposed on the current image A. In the resulting combined image C, the intervention device 8 is clearly visible to the doctor in a high-contrast vascular tree, whereby navigation of the instrument and placement of surgical treatment is appreciably facilitated.

Moreover, in the case of the combined display on the monitor 10, just one section of the map image B and/or one section of the current image A in the region of the object 8 can be used, in order, by limiting the registration region, to improve accuracy compared with a global registration.

1. A device for combined display of a current image (A) of an object (8), which is located in a path network (9), and a map image (B) of the path network (9), the device containing a data-processing system (5) that is arranged
a) in a map image (B) to identify the path network by segmentation;
b) to calculate from the segmentation result auxiliary information (D) and archive it in the memory of the data-processing system, from which a transformation (Q) that brings the object and path network into register can be determined in real time for every possible position of an object in the image;
c) from the current image (A) to segment a relevant object (8) that is located in the path network (9);
d) using the auxiliary information (D), to determine transformations (Q) of the map image (B) and of the current image (A), so that, when the transformed map image (Q(B)) is superimposed on the transformed current image (A), the image of the object (8) comes to lie in the path network of the transformed map image.

2. A device as claimed in claim 1, characterized in that the auxiliary information includes a distance image (D) in relation to the path network (9), which is obtained from the particular map image (B) by a distance transformation (D).

3. A device as claimed in claim 2, characterized in that the data-processing system (5) is arranged
b1) to determine the position of the image of the object (8) in the current image (A);
c1) for the position corresponding thereto in the distance image (D), to determine the shortest displacement leading into the path network (9);
c2) to identify a transformation (Θ) of the map image (B) and/or of the current image (A) that includes the determined displacement.

4. A device as claimed in claim 1, characterized in that the determined transformations (Θ) include a tanslation, a rotation and/or a scaling.

5. A device as claimed in claim 1, characterized in that the data-processing system (5) is arranged during segmentation of the path network (9) in the map image (B) to assign to each pixel a probability that it belongs to the network (9).

6. A device as claimed in claim 1, characterized in that it comprises an imaging arrangement, especially an X-ray apparatus (4) and/or an MRI apparatus, for recording the current image (A) and optionally the map image (B).

7. A device as claimed in claim 1, characterized in that it comprises a memory (6) for storing a number of map images (B), which are categorized according to a varying state of the path network (9).

8. A device as claimed in claim 1, characterized in that it comprises a sensor device (3) for detecting at least one parameter that describes a varying state of the path network (9), preferably for detecting an electrocardiogram and/or the respiratory cycle.

9. A device as claimed in claim 6, characterized in that the data-processing system (5) is arranged to select from the memory (6) a map image (B) of which the associated state of the path network (9) is the best possible match for the state of the path network (9) during the current recording (A).

10. A device as claimed in claim 1, characterized in that it contains a display device (10) and the data-processing system (5) is arranged to display on the display device (10) the transformed map image (Θ(B)) superimposed entirely or in sections on the transformed current image or a section thereof.

11. A method for combined display of a current image (A) of an object, which is located in a path network (9), and a map image (B) of the path network (9), comprising the following steps:
a) segmentation of the path network in the map image;
b) calculation and storage of auxiliary information from the segmentation result, wherein for every possible position of an object in the image a transformation that brings the object and path network into register can be determined in real time from the auxiliary information;
c) segmentation of a relevant object that is located in the path network from the current image;
d) determination of transformations of the map image and of the current image using the auxiliary information, so that, when the transformed map image and the transformed current image are superimposed, the image of the object comes to lie in the path network of the transformed map image.
